(19) United States
(12) Patent Application Publication
(10) Pub. No.: US 2012/0207876 A1
(43) Pub. Date: Aug. 16, 2012

(54) Food Product With Biocontrol And Method

(76) Inventor: Dennis Arthur Lonergan, Medina, FL (US)

(21) Appl. No.: 13/396,823

(22) Filed: Feb. 15, 2012

Related U.S. Application Data
(60) Provisional application No. 61/442,992, filed on Feb. 15, 2011.

(51) Int. Cl. A23L 3/00; B65D 85/00

(52) U.S. Cl. 426/8; 426/61

(57) ABSTRACT

A packaged food product and method are provided. The product includes biocontrol microorganisms adhered at least initially to a closure member that is attached to a container in which food product is contained. At least some of the biocontrol microorganisms are transferred to the food product after the closure member is attached to the container.

### CROSS REFERENCE TO RELATED APPLICATION

This application claims priority under 35 USC 119(e) to the U.S. Provisional Application 61/442,992, filed on Feb. 15, 2011, entitled “Food Product With Biocontrol And Method”, the contents of which are herein incorporated by reference.

### FIELD OF THE INVENTION

The invention relates to a food product that utilizes biocontrol microorganisms added to the food product.

### BACKGROUND OF THE INVENTION

Biocontrol is a technology which promotes food safety by facilitating the growth and metabolism of selected microorganisms to prevent the growth of hazardous microorganisms. Biocontrol is known as exemplified in U.S. Pat. Nos. 6,692,779 and 7,579,030. These patents require the use of pasteurization, in addition to the use of biocontrol material, to help effect deleterious microorganism control. Certain spores can survive pasteurization, and then under certain storage conditions become viable and contaminate the food product which can be controlled by the use of viable biocontrol material. Pasteurization conditions, though, create the specific conditions for toleration by the biocontrol agents because of the use of high temperature and high moisture environments which can damage or render the biocontrol organisms non viable. However, pasteurization can also inactivate the biocontrol microorganism. The cited patents disclose that in order to maintain viability of the biocontrol organisms, a quantity of the biocontrol organisms must be kept separate from moisture while the product temperature is above a temperature that would kill or damage the biocontrol organism. As taught by the '779 and '030 patents, the desirable microorganisms can be safeguarded from the heat in the presence of water through the use of dry microorganisms, i.e., containing less than about 15% by weight water. Damage to the biocontrol material is controlled by the patentees by applying the biocontrol material to the food after pasteurization and cooling or encapsulating dry biocontrol material to prevent contact with moisture, i.e. prevent hydration of the microorganism during the heat processing. For example, when processing filled dough products like pasta, the biocontrol material is disclosed as being applied after pasteurization and cooling in some examples. This, however, is disclosed as presenting potential problems since the food container needs to be open after pasteurization to apply the biocontrol material after the product cools. The biocontrol material can be mixed into the food product, as compared to a topical application, but then its moisture uptake during heating must be controlled. Damage to the biocontrol material for this latter method can be reduced by encapsulating dry biocontrol organisms to retard their hydration. Regardless, the biocontrol organisms are exposed to the moist food, necessitating keeping the biocontrol material away from the food product moisture and/or heat because when it is not dry, it is much more easily damaged by heat.

While the patents provide solutions, there are problems with the solutions. If a food product is not packaged hot in a substantially closed container for subsequent cooling, there is a risk of exposure of the food product to viable undesirable microorganisms from the environment. Thus, topical application after cooling presents a risk of subsequent contamination from the environment. The cited patents disclose that control of access to moisture can be accomplished by encapsulating the biocontrol organism in a dry state, but that then makes the system time dependent since many encapsulants have a time/temperature/moisture dependency before they break down or dissipate to expose the contents. This can create problems during large scale manufacturing since a product is held in large expensive equipment for the thermal processing, either pasteurization or cooking, and then large expensive equipment if cooling is to occur quickly. These can become HAACP points in a manufacturing plant, requiring extra control and expense. Pasteurization can be accomplished during a cooking process eliminating the need for a separate process step, but pasteurization does not necessarily mean that the product is adequately cooked, only pasteurized. Shelf stable foods are heat processed sufficiently to effect sterilization which can be detrimental to food product quality which typically is affected by additional heat processing. The need for sterilization can be reduced by storage techniques and food additives, however, additives are often consumer negatives. Cold storage can be used in place of sterilization. The water activity of the food product and its acidity can also be used to reduce the need for sterilization from heat processing, but as is known in the art, these can negatively impact flavor and also present additional consumer negatives.

Cooking is a form of heat processing that is intended to alter organoleptic or physical properties of a food product but may not be sufficient to effect pasteurization or sterilization in order to maintain the desired organoleptic properties of the food. Cold storage is available as a technique in providing a safe food with the desired organoleptic properties. Food products intended for cold storage, e.g., refrigerated and frozen, are even often pasteurized and/or cooked (heat processed) even though the storage temperature might be sufficient to preclude food spoilage. Cold storage is often used to reduce the amount of upstream processing, in order to reduce the risk of spoilage and to avoid degrading the quality of the food product. There is a balance between food quality and safety when using a storage technique. But, a problem in food distribution systems is storage stress, particularly for cold storage foods. The temperature of refrigerated and frozen foods can inadvertently increase during storage to levels where microorganisms or spores are again viable and can result in deleterious organisms in quantities that might make consumption of the food undesirable or even unsafe. In many cases, particularly in food products having particulates surrounded by water as in soups, overcooking, which can occur in order to achieve pasteurization or sterilization conditions, even for cold storage food products, can degrade the organoleptic properties of the food product, e.g., the particulates becoming mushy. There is thus a need for an improved biocontrol system for processed foods.

Biocontrol has been studied and is described in the literature; “Using Lactic Acid Bacteria to Improve the Safety of Minimally Processed Fruits & Vegetables” Breidt et al., Food Technology, September 1997, Vol. 51, No. 9, pp 44-51. Its application to refrigerated foods is discussed “Inhibition of Botulinum Toxin Production by Pediococcus acidilactici in Temperature Abused Refrigerated Foods” Hutton et al., Journal of Food Safety Vol. 11 1991, pp. 255-267. Basically, the biocontrol organisms produce acid when the food temperature increases and they need to be in a sufficient quantity after processing to produce an effective amount of acid.

One of the technical challenges facing the use of biocontrol techniques in pasteurized refrigerated foods is that the temperature reached in pasteurization also inactivates the biocontrol microorganisms when they are not dry as disclosed in the cited patents. It has been considered unacceptable to pasteurize and then cool the food before adding the biocontrol organisms because of the concern for recontamination of the food with vegetative cells of undesirable microorganisms. means of circumventing this challenge is to encapsulate dry bacteria and add them to the food prior to pasteurization. This approach relies on the decreased thermal sensitivity of dry versus hydrated microorganisms. This method is described by Domingues and Hanlin in U.S. Pat. Nos. 6,692,779 and 7,579,030 discussed above. However, both the approaches disclosed by these patents present problems.

The problem is thus to provide an improved way of using a biocontrol organism that can be included in a food package either during or immediately after thermal processing that effectively keeps the microorganism alive in a reliable manner to provide its preservation activity as needed. This eliminates the need for encapsulation of a microorganism and exposed product processing as taught in the U.S. Pat. Nos. 6,692,779 and 7,579,030.

### SUMMARY OF THE INVENTION

The present invention involves the provision of a packaged food product. The product includes a container with an access opening. A food product is contained in the container and a closure member is secured to the container at least substantially closing the access opening and is normally spaced from the food product. A quantity of biocontrol microorganisms is adhered at least initially to the closure member and exposed for selective contact with the food product.

The present invention also involves the provision of a method of packaging food. The method includes heating food for a time and at a temperature to at least one of cook and pasteurize the food. An effective amount of biocontrol microorganisms is applied on a surface of a container closure member for adherence thereto. The closure member is at least substantially sealed to a container with at least some of the heated food (while still hot) being in the container.

At least some of the biocontrol microorganism is transferred to the food by contacting the food with the biocontrol microorganism after the sealing is accomplished and after the temperature of the food has decreased to the point where it will no longer inactivate (kill) the biocontrol organisms.

This present invention involves the provision of a method of biocontrol wherein the biocontrol microorganisms are affixed to an interior surface of a container closure member of a food package. This closure member is applied to the product container after the product has been thermally processed. The food material is preferably still hot (at or above a temperature which would be lethal to the beneficial microorganisms) when the food container is at least substantially closed with the closure member. The biocontrol organisms are kept at a temperature which assures that a viable quantity survive the exposure to the heat of the food product by applying a cooling fluid such as water to the exterior of the closure member while the product itself is also being cooled. Once the product is at a temperature which is not injurious to the biocontrol organisms, the food product container may be inverted to enhance inclusion of the biocontrol microorganisms in the food product. The product can then be further cooled for cold storage such as at refrigerated temperatures, typically 33°-40° F. The food product may also be stored at frozen temperatures below 32° F., and preferably below about 10° F.

The result of practicing this invention is that if the food product is subsequently thermally abused (e.g. stored at temperatures above 40°-50° F.), the biocontrol organisms will grow and prevent the growth of hazardous microorganisms. Spore forming organisms such as Clostridia botulinum are the organisms of concern, as the pasteurization of the food product should eliminate vegetative cells of hazardous microorganisms. Examples of these vegetative cells include those from the genera Salmonella, E Coli and Lysteria. Growth of Clostridia botulinum is prevented because the biocontrol organisms are selected to be ones that reduce the pH of the food or that produce a bacteriocin. Biocontrol organisms for this application include organisms from the genera Lactobacillus, Pediococcus, Streptococcus, Leuconostoc and Bacillus.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an exploded perspective view of a container with food therein with portions broken away to show the container interior.

FIG. 2 is a sectional view of the container of FIG. 1.

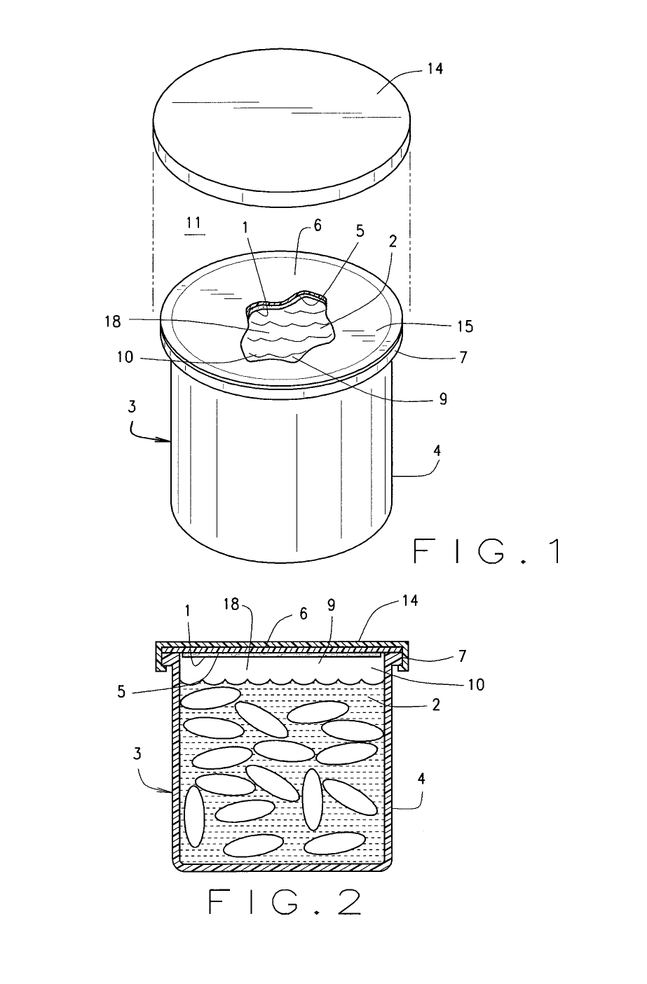

### DETAILED DESCRIPTION OF THE INVENTION

In a preferred embodiment of the present invention the biocontrol microorganisms 1 are added after the food product 2 is thermally processed and filled into the container 3 but while still hot. The food product 2 preferably contains drainable water. The container 3 has a receptacle 4 having a food storage compartment 10. This process step is referred to in the art as hot fill. In a hot fill process, the product 2 can still be hot enough, when it is filled into the container 3, to cause lethality to vegetative cells of microorganisms 1. The biocontrol organisms 1 should not be added directly to the hot product 2 if a high level of their viability is to be maintained. Preferably, the biocontrol microorganisms 1 are added to the container 3, and subsequently the food 2 via their adherence to the interior surface 5 of a closure member 6 of the container 3.

A preferred container 3 receptacle 4 is of a molded polymeric construction, however, any suitable container construction may be used, including metal and glass containers. A preferred closure system for the container 3 includes the closure member 6 in the form of a thin polymeric film suitably attached to a lip 7 surrounding a container access opening 9. The closure member 6 at least substantially closes the container 3, storage compartment 10 and the opening 9 forming a barrier between the interior and exterior 11 of the container 3. The attachment may be by a heat seal or adhesive. As known, an over lid 14 may be provided and removably secured to the container 3 in overlying relation to the closure member 6. The closure member 6 is normally spaced from the food product 2 forming an air gap 18 or headspace therebetween. The biocontrol organisms 1 are adhered to the closure member 6 on the inside surface 5 thereof and are exposed to the food product 2 that has drainable water. It is to be understood that the receptacle 4 can be sealed with a single piece closure member as is known in the art. Such a closure could be in the form of a screw on lid, a crimped on lid or a heat sealed lid. Preferably, the receptacle 4 is sufficiently rigid to maintain the air gap 18 in one position during processing and maintain the biocontrol organisms 1 out of contact with water in the compartment 10.

The closure member 6 is secured to the container 3 while the product 2 is still hot. Thus, the biocontrol organisms 1 are not directly subjected to potentially lethal heat of the product 2 because it is separated from the product 2 and its water by the air gap 18. The biocontrol organisms can be further protected by the application of cooling fluid such as water or air to the exterior surface 15 of the closure member 6. This is in fact often common practice to facilitate the cooling of the food product following a hot fill operation. After the food product 2 is cooled to a temperature which is not lethal to the biocontrol microorganisms 1 when wet, the product container 3 may be inverted to facilitate the dispersal of the biocontrol microorganisms into the food product 2 by contact with water in the food product 2. This dispersion of the biocontrol organisms 1 renders them viable for biocontrol. An example food product 2 is refrigerated soup. It is to be understood that the closure member 6 and over lid 14 can be a single piece closure member as are used to form a metal container, where attachment to the receptacle 4 can be by crimping as is known in the art.

The biocontrol organisms 1 can be applied to the closure member 6 by a number of methods. The biocontrol organisms 1 are applied to the closure member 6 in an effective amount for the type and quantity of food product to be protected. The simplest method is somewhat analogous to how a slide of a culture of microorganisms is prepared for observation under a microscope. In this procedure, an aqueous suspension of the biocontrol organisms 1 is applied to the closure member 6. The applied suspension of biocontrol organisms 1 can be used as is or dried depending on the food product processing procedure. In one process, the water in the suspension is evaporated away with a stream of warm air prior to applying the closure member 6 to the receptacle 4, or even after application of the closure member if desired. The biocontrol organisms 1 are preferably dried to a total moisture content of below about 15% by weight. The adherence of the biocontrol organisms 1 to the closure member 6 can be accomplished by the addition of carbohydrates and/or hydrocolloids (gums) to an aqueous suspension of biocontrol microorganisms 1. These carbohydrates would be food grade ingredients, ranging from monomers such as dextrose to complex carbohydrates such as starches and gums. The biocontrol organisms 1 and adhesive material are applied to the surface 5 after which the water in the aqueous suspension can be dried in a manner that does not damage or render nonviable the biocontrol organisms 1. This is accomplished by keeping the drying temperature below the lethal temperature for the particular biocontrol organisms 1. The closure member 6 can also be secured to the receptacle 4 with the biocontrol organisms 1 still being in an aqueous suspension if the product processing temperature is not lethal to the biocontrol organisms.

The amount of the biocontrol organism 1 can vary over a wide range, depending on the amount of food product 2 and the type of organism used, an amount in the range of between about 10 cfu's/gram of food product and about 1,000,000 cfu's/gram of food product has been found to be effective.

Alternately, the food product 2 can be thermally treated in the container 3 after the container is filled if the closure member 6 is applied to the container 3 following this thermal treatment. The thermal processing of the food 2 may be for the accomplishment of cooking and/or pasteurization. The particular food product 2 will determine the time and temperature of the thermal processing used to accomplish cooking and/or pasteurization.

The food product 2 containing the biocontrol organisms 1 in its container 3 may then be appropriately stored, such as under cold storage conditions such as refrigerated or frozen storage conditions. Typically, refrigerated storage is at less than about 40° F., and frozen storage is less than about 32° F. and preferably less than about 10° F.

This present invention involves the provision of a method of biocontrol wherein the biocontrol microorganisms 1 are affixed to the interior surface 5 of a container closure member 6 of a food package 3. The closure member 6 is applied to the receptacle 4 after the product 2 has been then ally processed. The food material is preferably still hot (at or above a temperature which would be lethal to the beneficial microorganisms) when the food container is at least substantially closed with the closure member. The biocontrol organisms 1, when in suspension, are kept at a temperature which assures that a viable quantity survive the exposure to the heat of the food product by applying a cooling fluid such as water to the exterior of the closure member while the product itself is also being cooled. Once the product is at a temperature which is not injurious to the biocontrol organisms, the food product container may be inverted to enhance inclusion of the biocontrol microorganisms 1 from a suspension or dry form in the food product 2. The product can then be further cooled for cold storage such as at refrigerated temperatures, typically 33° F.-40° F. The food product may also be stored at frozen temperatures below 32° F. and preferably below about 10° F.

The result of practicing this invention is that if the food product is subsequently thermally abused (e.g. stored at temperatures above 40°-50° F.), the biocontrol organisms will grow and prevent the growth of hazardous microorganisms. Spore forming organisms such as Clostridia botulinum are the organisms of concern, as the pasteurization of the food product should eliminate vegetative cells of hazardous microorganisms. Examples of these vegetative cells include those from the genera Salmonella, E Coli and Lysteria. Growth of Clostridia botulinum is prevented because the biocontrol organisms are selected to be ones that reduce the pH of the food or that produce a bacteriocin. Biocontrol organisms for this application include organisms from the genera Lactobacillus, Pediococcus, Streptococcus, Leuconostoc and Bacillus.

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A packaged food product comprising:
a container with a receptacle having an access opening;
a food product contained in the container;
a closure member secured to the receptacle of the container at least substantially closing said access opening and normally spaced from the food product; and
a quantity of biocontrol microorganisms adhered at least initially to the closure member and exposed for selective contact with the food product.

2. The food product of claim 1 wherein the closure member including a thin film secured to an upper portion of the receptacle and having the quantity of biocontrol microorganisms secured thereto and spaced from the food product by an air gap.

3. The food product of claim 2 including an over lid mounted to the receptacle.

4. A method of packaging food:
heating food for a time and at a temperature to at least one of cook the food and pasteurize the food;
applying an effective amount of biocontrol microorganisms on a surface of a container closure member for adherence thereto;
at least substantially sealing the closure member to a container receptacle with at least some of the heated food therein; and
transferring at least some of the biocontrol microorganisms to the food by contacting the food with the biocontrol microorganism after the sealing.

5. The method of claim 4 including cooling the food in the container after the sealing and storing the cooled food under cold storage conditions.

6. The method of claim 4 including drying the biocontrol microorganisms after said applying and before said sealing.

7. The method of claim 4 wherein the biocontrol microorganisms having a total moisture content of less than about 15% by weight prior to said transferring.

8. The method of claim 4 wherein the biocontrol microorganisms being dried to a total moisture content of less than about 15% by weight after said applying.
